(19) United States
(12) Patent Application Publication
(10) Pub. No.: US 2014/0133707 A1
(43) Pub. Date: May 15, 2014

(54) MOTION INFORMATION ESTIMATION METHOD AND IMAGE GENERATION APPARATUS USING THE SAME

(71) Applicant: Samsung Electronics Co., Ltd., Suwon-si (KR)

(72) Inventors: Byun-kwan Park, Seoul (KR); Tae-yong Song, Hwaseong-si (KR); Jae-mock Yi, Hwaseong-si (KR)

(73) Assignee: SAMSUNG ELECTRONICS CO., LTD., Suwon-si (KR)

(21) Appl. No.: 14/055,297

(22) Filed: Oct. 16, 2013

(30) Foreign Application Priority Data
Nov. 14, 2012 (KR) 10-2012-0129095

(51) Int. Cl. G06T 7/20

(52) U.S. Cl. CPC G06T 7/2033
USPC 382/107

(57) ABSTRACT

A motion information estimation method and an image generation apparatus are provided. The image generation apparatus may include an image data obtaining unit for obtaining image data of the anatomic features of a subject. The image generation apparatus may also include a region-of-interest (ROI) determining unit for determining a ROI in the image data, where motion is generated in the ROI corresponding to motion of the subject. The apparatus may also include a sinogram generating unit for generating first sinograms corresponding to a plurality of states of the ROI from data obtained from the subject during a first time. Additionally, the apparatus may include an extracting unit for extracting feature values of the subject from the first sinograms, respectively, and a motion information estimating unit for estimating motion information of the subject by referring to the feature values of the subject with respect to the plurality of states.

### CROSS-REFERENCE TO RELATED APPLICATION

This application claims the benefit under 35 U.S.C. §119(a) of Korean Patent Application No. 10-2012-0129095, filed on Nov. 14, 2012, in the Korean Intellectual Property Office, the entire disclosure of which is incorporated herein by reference for all purposes.

### BACKGROUND

1. Field

The following description relates to a motion information estimation method and an image generation apparatus using the motion information estimation method.

2. Description of Related Art

A diagnostic image of a subject is typically obtained using a medical imaging device or technique such as computer tomography or positron emission tomography. In positron emission tomography, gamma rays emitted by a radioactive isotope injected into a subject are irradiated to the subject and a diagnostic image is obtained. The diagnostic image is typically obtained based on the amount of absorption or attenuation of the gamma rays. Similarly, in computer tomography, absorption or attenuation of radioactive rays, such as X rays, are detected for obtaining a diagnostic image. Typically, in addition to the data collected for generating the diagnostic image of the subject, users may also desire to collect data related to the subject's motion or pattern of movement.

### SUMMARY

In one general aspect, there is provided an image generation apparatus having an image data obtaining unit configured to obtain image data comprising anatomic information of a subject; a region-of-interest (ROI) determining unit configured to determine a ROI in the image data corresponding to a region in which motion is generated in response to the subject's movement; a sinogram generating unit configured to generate first sinograms corresponding to a plurality of states of the ROI from data obtained during a predetermined first time; an extracting unit configured to extract feature values of the plurality of states from the first sinograms; and a motion information estimating unit for estimating motion information of the subject based on the feature values.

The motion generated in the ROI may be a motion generated by the subject's diaphragm during a breathing motion of the subject, and the ROI comprises at least a part of a cell, a tissue, or an organ which is located adjacent to the diaphragm.

The ROI may comprise a part of a cell, a tissue, or an organ which has the largest amount of data emitted by a tracer among cells, tissues, or organs which are located adjacent to the diaphragm.

The ROI determining unit may automatically determine the ROI or manually determine the ROI based on input information input by a user of the image generation apparatus, and the ROI may comprises at least one of a part of a tumor cell, a tumor tissue, or a liver.

The sinogram generating unit may comprise an eleventh sinogram generating unit configured to generate eleventh sinograms corresponding to a first direction of the ROI for the plurality of states based on location information with respect to the first direction of the ROI obtained from the image data; a twelfth sinogram generating unit configured to generate a twelfth sinogram corresponding to a second direction and a third direction of the ROI by using projection data obtained by projecting the ROI onto a plane, which is defined by the second direction and the third direction; and a first sinogram generating unit configured to extract a region corresponding to the twelfth sinogram from the eleventh sinograms and to generate the first sinograms for the plurality of states of the ROI.

The eleventh sinogram generating unit may obtain first data from the subject during the first time and arrange the first data at intervals of a second time, extract second data corresponding to the location information within the first direction of the plurality of states of the ROI from the first data, and combine the second data for the plurality of states, respectively, thereby generating the eleventh sinograms corresponding to the plurality of states of the ROI.

The eleventh sinogram generating unit may obtain the first data by using a data binning method with respect to time.

The feature values of the subject may comprise the amount of data emitted by a tracer injected into the subject.

The motion information estimating unit may estimate the motion information of the subject based on a pattern of a sum of the feature values with respect to the plurality of states.

The image generation apparatus may further comprise an image generating unit configured to generate an image of the subject based on the estimated motion information.

In another aspect, there is provided an image generation apparatus comprising a detector for detecting data corresponding to a plurality of states occurring in response to a subject's movement during a predetermined first time; and a main system for determining a region-of-interest (ROI) corresponding to a region in which motion is generated in response to the subject's movement, generating first sinograms corresponding to the plurality of states of the ROI from the detected data, estimating motion information of the subject based on feature values of the plurality of states, and generating a gated image based on the estimated motion information.

The image generation apparatus may further comprise a motion correcting unit configured to calculate data or image error of a first state of the plurality of states with respect to one or more other states of the plurality of states in order to correct the data or image error in the first state.

In another aspect, there is provided a motion information estimation method comprising obtaining image data comprising anatomic information of a subject; determining a region-of-interest (ROI) in the image data corresponding to a region in which motion is generated in response to the subject's movement; generating first sinograms corresponding to a plurality of states of the ROI from data obtained during a predetermined first time; extracting feature values of the plurality of states from the first sinograms; and estimating motion information of the subject based on the feature values.

The motion generated in the ROI may occur in response to motion generated by the subject's diaphragm during a breathing motion of the subject, and the ROI may comprise at least a part of a cell, a tissue, or an organ which is located adjacent to the diaphragm.

The ROI may comprise a part of a cell, a tissue, or an organ which has the largest amount of data emitted by a tracer among cells, tissues, or organs which are located adjacent to the diaphragm, and the ROI may be automatically determined or manually determined with reference to input information input by a user.

The generating of the first sinograms may include generating eleventh sinograms corresponding to a first direction of the ROI of the plurality of states based on location information with respect to the first direction of the ROI obtained from the image data; generating a twelfth sinogram corresponding to a second direction and a third direction of the ROI by using projection data obtained by projecting the ROI onto a plane, which is defined by the second direction and the third direction; and extracting a region corresponding to the twelfth sinogram from the eleventh sinograms to generate the first sinograms for the plurality of states of the ROI.

The generating of the eleventh sinograms may include obtaining first data from the subject during the first time and arranging the first data at intervals of a second time; extracting second data corresponding to the location information within the first direction of the plurality of states of the ROI from the first data; and combining the second data for the plurality of states, respectively, to generate the eleventh sinograms corresponding to the plurality of states of the ROI.

The obtaining of the first data may be performed by using a data binning method with respect to time.

The feature values of the subject may comprise the amount of data emitted by a tracer injected into the subject.

The motion information estimation method may further include estimating the motion information of the subject based on a pattern of a sum of the feature values with respect to the plurality of states.

In another aspect, there is provided a computer-readable recording medium having recorded thereon a computer program for executing the motion information estimation method on a computer.

### BRIEF DESCRIPTION OF THE DRAWINGS

FIG. 1 is a diagram illustrating an example of an image generation apparatus.

FIG. 2 is a block diagram illustrating an example of a motion information estimation apparatus.

FIG. 3 is a block diagram illustrating an example of the sinogram generator of FIG. 2.

FIG. 4 is a diagram illustrating an example of a pattern of a sum of feature values of a subject with respect to a plurality of states corresponding to motion of the subject.

FIG. 5 is a diagram illustrating an example of a plurality of states of regions of interest (ROIs).

FIG. 6 is a diagram illustrating an example of a process of generating first sinograms in the sinogram generator of FIG. 2.

FIG. 7 is a diagram illustrating an example of a motion information estimation method.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

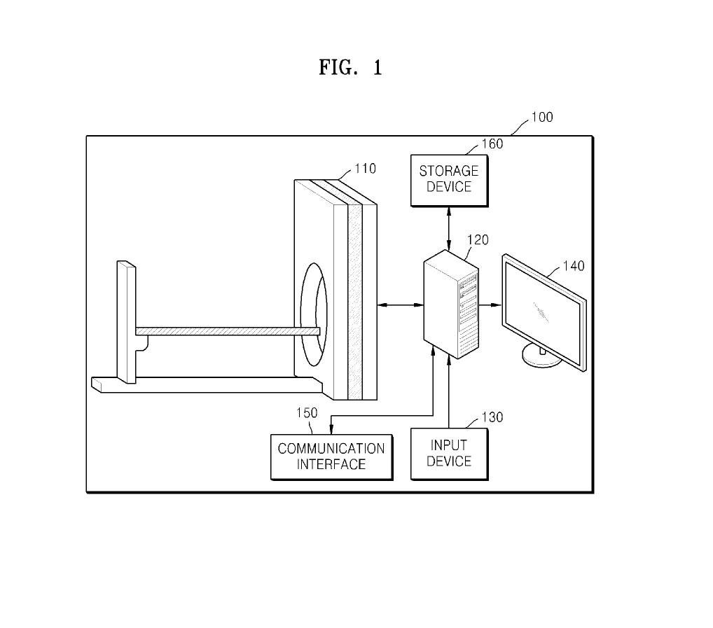

FIG. 1 illustrates an example of an image generation apparatus 100. Referring to FIG. 1, the image generation apparatus 100 may include a detector 110, a main system 120, an input device 130, an output device 140, a communication interface 150, and a storage device 160.

The image generation apparatus 100 illustrated in FIG. 1 may include only components related with the current embodiment. Therefore, those of ordinary skill in the art may understand that general-purpose components other than those illustrated in FIG. 1 may be further included in the image generation apparatus 100.

The image generation apparatus 100 may generate an image from data obtained from a subject. For example, the image may include a medical image, a diagnostic image or the like. The medical or diagnostic image may include anatomical, physiological, or other biological information about the subject. The apparatus 100 for generating an image may include, for example, a positron emission tomography (PET) device, a computed tomography (CT) device, a PET/CT device, a single photon emission computed tomography (SPECT) device, a SPECT/CT device, or other medical imaging device.

The detector 110 may detect measurement data from the subject. For example, the detector 110 may detect a radioactive ray passing through the subject or a gamma ray emitted from the subject.

For example, the apparatus 100 for generating an image may be a PET device, and a tracer may be injected into the subject. A positron emitted from the tracer collides and annihilates with an electron from the subject's body, thereby producing two gamma rays. Each of the two gamma rays may have an energy level of about 511 keV and an angle of about 180° therebetween. In this example, the tracer may be a radioactive isotope, a radioactive tracer, or a radioactive isotope tracer. As another example, the apparatus 100 may be a CT device, and radioactive rays passing through the subject may be detected.

In an example, the detector 110 may obtain information about the two gamma rays in the form of line-of-response (LOR) data. In this example, LOR data may include information such as an angle at which the two gamma rays are incident to the detector 110, a distance from the emission point of the gamma rays to the detector 110, a time at which the two gamma rays are detected, and other information relating to the detected rays. The angle at which the two gamma rays are incident to the detector 110 may be, for example, a projection angle of gamma ray data obtained from the subject. The distance from the emission point of the gamma rays to the detector 110 may be, for example, a displacement of the gamma ray data obtained from the subject as measured from the point of emission. In one example, the detector 110 may merely perform an operation of obtaining the gamma rays and an operation of obtaining the LOR data may be performed in the main system 120. In an alternative example, the detector 110 may both obtain the gamma rays and perform an operation of obtaining the LOR data.

The detector 110 may detect measurement data from the subject during a predetermined time, such that the measurement data may correspond to a plurality of different states of the subject. Each of the plurality of different states may be different as a result of the movement of the subject or movement within the subject's anatomy while the data is measured during the predetermined time. For example, if the subject is a human body, or an organ or a tissue of the human body, periodic motion may be generated corresponding to the breathing or heartbeat motion within the human body. Thus, the measurement data detected by the detector 110 for the predetermined time may include information about the subject which has various states corresponding to the different positions resulting from the subject's motion.

In an example, the apparatus 100 may also include a main system 120 for generating an image using the measurement data detected from the subject. For example, the main system 120 may estimate the subject's motion information included in the measurement data detected from the subject, and refer to the estimated motion information to generate a gated image. When estimating the motion information, the main system 120 may determine an anatomical region of interest (ROI), included in the image data, in which motion is generated as a result of the subject's motion. In this example, the main system 120 may generate first sinograms corresponding to each of the plurality of states of the ROI. Further, the main system 120 may refer to feature values extracted from the first sinograms of each of the plurality of states to estimate motion information for the subject.

In an example, the apparatus 100 may also include an input device 130 and an output device 140. The input device 130 may obtain input information from a user, and the output device 140 may display output information. While the input device 130 and the output device 140 are illustrated as separate devices in FIG. 1, they may be integrated into one device without being limited to the illustrated example. For example, the input device 130 may include a mouse, a keyboard, or the like, and the output device 140 may include a monitor or other display device. As the input device 130 and the output device 140 are integrated into one device, they may also be implemented in the form of a touch pad, cellular phone, a personal digital assistant (PDA), a handheld e-book, a portable laptop PC, a tablet, a sensor, a desktop PC, or other integrating device.

In an example, the apparatus 100 may also include a communication interface 150. The communication interface 150 may transmit and receive data with another device (not shown) located outside the image generation apparatus 100. For example, the communication interface 150 may transmit and receive data by using a wired/wireless network and wireless serial communication. Examples of the network may include Internet, a local area network (LAN), a wireless LAN, a wide area network (WAN), a personal area network (PAN), or any other type of network capable of transmitting and receiving information.

In an example, the apparatus 100 may also include a storage device 160. The storage device 160 may store data generated during operations of the image generation apparatus 100 and/or data for performing the operations of the image generation apparatus 100. For example, the storage device 160 may be a general storage medium. Examples of storage media may include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like.

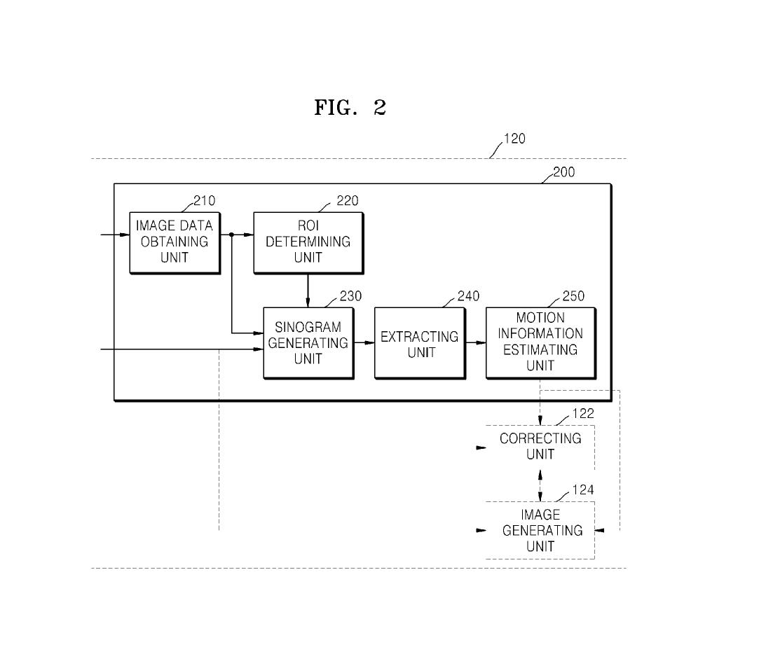

FIG. 2 is a block diagram illustrating an example of a motion information estimation apparatus 200. Referring to FIG. 2, the motion information estimation apparatus 200 may include an image data obtaining unit 210, a ROI determining unit 220, a sinogram generating unit 230, an extracting unit 240, and a motion information estimating unit 250.

The motion information estimation apparatus 200 illustrated in FIG. 2 includes only components related with the current embodiment. Therefore, those of ordinary skill in the art may understand that general-purpose components other than those illustrated in FIG. 2 may be further included in the motion information estimation apparatus 200. The motion information estimation apparatus 200 and the components included in the motion information estimation apparatus 200 illustrated in FIG. 2 may correspond to one processor or a plurality of processors.

In an example, the motion information estimation apparatus 200 illustrated in FIG. 2 may be included in the main system 120 of the image generation apparatus 100 of FIG. 1. Thus, in this example, the main system 120 may include the motion information estimation apparatus 200, a correcting unit 122, and an image generating unit 124.

The motion information estimation apparatus 200 may estimate motion information of the subject included in the data obtained from the subject. For example, the subject's motion information may be a respiratory phase, a cardiac cycle phase, or other phase of a biological cycle of the subject.

In an example, the motion information estimation apparatus 200 may include an image data obtaining unit 210. The image data obtaining unit 210 may obtain image data including the anatomical or other biological information of the subject. For example, the image data may correspond to a CT image, a magnetic resonance image, or other medical image of the subject.

The image data obtaining unit 210 may, for example, obtain the image data corresponding to the image of the subject from outside the motion information estimation apparatus 200. Alternatively, and in another example, the image data obtaining unit 210 may also include a medical image capturing device for capturing the medical image of the subject such as a CT image capturing device or a magnetic resonance image capturing device.

The motion information estimation apparatus 200 may also include a ROI determining unit 220. The ROI determining unit 220 may determine a ROI within the image data. The ROI may be a region in which motion is generated as a result of the motion of the subject. The ROI may, for example, be a three-dimensional (3D) region defined with respect to an x axis, a y axis, and a z axis. For example, the ROI may include at least one of a part of a tumor cell, tumor organ, or the liver of the subject.

For example, if the subject's motion is a breathing motion, the ROI generates movement according to the diaphragm's motion. The movement of the diaphragm is generally corresponding to the breathing motion of the subject because the diaphragm is contracted or relaxed in conjunction with the contraction and relaxation of the lungs. Accordingly, in this example, the ROI may include at least a part of a cell, a tissue, or an organ which is adjacent to the diaphragm, and similarly generates movement as a result of the moving diaphragm.

It should be appreciated that in a bone or an organ having rigid properties, even if located adjacent to the diaphragm, relatively small motion may be generated according to the subject's breathing motion. In an example, the ROI may be at least a part of a cell, a tissue, or an organ in which relatively much motion is generated as a result of the diaphragm's motion. Alternatively, and in another example, the ROI may also be a region where relatively less motion is generated.

For example, if the motion information estimation apparatus 200 is included in a PET device, the ROI may include at least a part of a cell, a tissue, or an organ in which the amount of data emitted by a tracer injected into the subject is largest in a region of a predetermined size or relatively large when compared with other cells, tissues, or organs located adjacent to the diaphragm.

It should be appreciated that in a medical image of the subject, a region in which the amount of emitted data is relatively large may have a higher contrast than a region in which the amount of emitted data is relatively small. Accordingly, when referring to the medical image of the subject, a region in which the amount of emitted data is large may be more easily identifiable than a region in which the amount of emitted data is small.

For example, if the tracer is fludeoxyglucose (18F, FDG), the amount of data emitted from the liver, the tumor cell, or the tumor tissue located adjacent to the diaphragm is larger than the amount of data emitted from the diaphragm. This generally results from glucose metabolism by the liver, tumor cell, or tumor tissue being greater than glucose metabolism by the diaphragm. Accordingly, in this example, the ROI may include at least a part of a cell, a tissue, or an organ in which the amount of data emitted by the tracer injected into the subject is largest or relatively large within a region of a predetermined size. The predetermined size may indicate a minimum region size necessary for motion information estimation. The predetermined size according to the current embodiment may be automatically determined according to a usage environment or may be determined with reference to input information that is input by the user.

Thus, in this example, the ROI may include at least one of a part of a tumor cell, a tumor tissue, the liver, or other anatomical structure.

In an example, the operation of determining the ROI may be automatically performed by the ROI determining unit 220 by analyzing the image data. Alternatively, and in another example, the ROI determining unit 220 may manually determine the ROI by referring to manual input information that is input by the user of the motion information estimation apparatus 200. The user may refer to the image data displayed on the output device 140 and may select a region corresponding to the ROI by using the input device 130. In this example, the ROI determining unit 220 may determine the ROI by referring to the input information from the user.

The motion information estimation apparatus 200 may include a sinogram generating unit 230. The sinogram generating unit 230 may generate first sinograms corresponding to each of the plurality of states of the ROI. As previously discussed, the plurality of states may correspond to different states of an anatomical structure resulting from movement of the subject. Accordingly, in this example, the first sinograms may be generated from data corresponding to the subject's motion as data is obtained from the subject during a predetermined first time.

For example, the generated first sinograms may include a graph displaying the results of gamma ray emission or radioactive ray attenuation resulting from a PET or CT imaging technique. In this example, each of the first sinograms generated in the sinogram generating unit 230 may be arranged in a form in which data is displayed on a graph according to an angle of projection of the gamma ray or radioactive ray and the rays displacement from the point of emission.

For example, if the subject's motion according to the current embodiment is a breathing motion, the states of the subject corresponding to the breathing motion in one respiratory phase are repeated in every respiratory phase. Therefore, the plurality of states may correspond to the states of the subject in a plurality of respective time periods having a predetermined time interval within one respiratory phase. For example, each of the plurality of respective states may occur within a single respiratory phase.

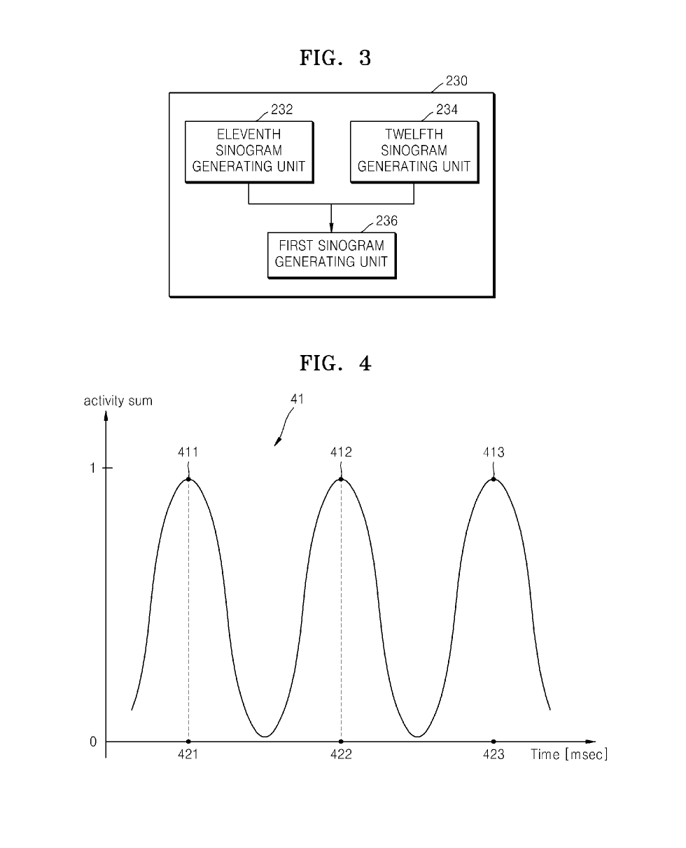

The sinogram generating unit 230 may also generate other sinograms, eleventh sinograms (S₁₁) for each of the plurality of states and a twelfth sinogram (S₁₂), which are used for generating the first sinograms of the plurality of states. The eleventh sinograms corresponding to each of the plurality of states may correspond to a first direction of the plurality of states of the ROI. The twelfth sinogram may correspond to a second direction and a third direction of the ROI. Also, in this example, the sinogram generating unit 230 may extract a region corresponding to the twelfth sinogram from the eleventh sinograms, and generate first sinograms corresponding to the plurality of states of the ROI by using the extraction result. In the following description, the sinogram generating unit 230 will be described in detail with reference to FIG. 3.

FIG. 3 is a block diagram illustrating an example of the sinogram generator 230. Referring to the example in FIG. 3, the sinogram generator 230 may include an eleventh sinogram generating unit 232, a twelfth sinogram generating unit 234, and a first sinogram generating unit 236.

The eleventh sinogram generating unit 232 may generate eleventh sinograms corresponding to a first direction of each of the plurality of states of the ROI from the obtained data. The eleventh sinograms may be generated by referring to location information with respect to the first direction of the ROI obtained from the image data.

For example, the eleventh sinogram generating unit 232 may obtain the location information with respect to the first direction of the ROI from the image data. The image data may be image data corresponding to the CT image or the magnetic resonance image obtained from the image data obtaining unit 210. Thus, the eleventh sinogram generating unit 232 may automatically obtain the location information with respect to the first direction of the ROI by referring to pixel values of pixels forming the image data. Alternatively, and in another example, the eleventh sinogram generating unit 232 may manually obtain the location of the first direction of the ROI based on information input from the user of the motion information estimation apparatus 200. In this example, the ROI may be a region having a relatively high contrast, such that the location information with respect to the first direction of the ROI may be automatically obtained by the eleventh sinogram generating unit 232.

For example, the location information with respect to the first direction of the ROI may correspond to location information in the direction of a z axis of the ROI. More specifically, the location information with respect to the first direction of the ROI may indicate coordinate information of end-points with respect to the z axis among outermost points of the ROI.

In this example, the image data may be 3D image data of a CT image and the image data may exist in the form of a stack of 2D slices, such as slices #1 through #100 along the z axis. In the example where the liver is the ROI, if it is predicted that the liver may appear on slices #50 through #75 along the z axis, the location information with respect to the first direction of the ROI may indicate location information regarding slices #50 through #75 in the z axis direction. In this example, it may predicted that the liver will appear on slices #50 through #75 along the z axis, even if the liver actually appears on slices #55 through #75 of the image data. This prediction may be made in order to account for motion of the liver along the z-axis resulting from the subject's movement.

The eleventh sinogram generating unit 232 may generate the eleventh sinograms corresponding to the first direction of each of the plurality of states of the ROI from the data obtained. In this example, the data obtained on the plurality of states may be data obtained from the subject during a predetermined first time, and may be, for example, PET data or CT data.

For example, if the plurality of states include first through third states, the eleventh sinogram generating unit 232 may generate three eleventh sinograms corresponding to three states of the ROI. More specifically, the eleventh sinograms of the first through third states of the ROI may be generated from the data including the first through third states corresponding to the subject's motion.

For example, the eleventh sinogram generating unit 232 may generate the eleventh sinogram of the first state of the ROI corresponding to the first direction from data obtained when an anatomical structure of the subject is in the first state, generate the eleventh sinogram of the second state of the ROI corresponding to the first direction from data obtained when the anatomical structure of the subject is in the second state, and generate the eleventh sinogram of the third state of the ROI corresponding to the first direction from data obtained when the anatomical structure of the subject is in the third state. The data for the respective first through third states of the subject may indicate that the data emitted from the subject is detected at predetermined time intervals.

In this example, the eleventh sinogram generating unit 232 may obtain first data obtained from the subject during the first time. The first data may then be arranged at intervals of a second time. In this example, the eleventh sinogram generating unit 232 may extract second data corresponding to the location information regarding the plurality of states of the ROI in the first direction from the first data, and combines the second data with the plurality of states, respectively, thereby generating the eleventh sinograms corresponding to the plurality of states of the ROI.

In this example, the eleventh sinogram generating unit 232 may use a data binning method with respect to time to obtain the first data. For example, the data obtained from the subject during the first time may be list mode data, event-by-event data, or frame mode data. The second time intervals may be, for example, such a short time that blur does not occur due to the subject's motion.

In this example, the list mode data obtained from the subject during the first time may be data obtained at an event occurring time instant. For example, the list mode data may provide information indicating that a detector #1 and a detector #3 react after 1.0 second and information indicating that a detector #2 and a detector #5 react after 2.4 seconds during the first time. In this example, when the data binning operation is performed with respect to the list mode data at the second time intervals, if the second time is 1 second, the first data may be arranged to data which is obtained from 0 second to 1 second and data which is obtained from 1 second to 2 seconds.

Thus, the first data may be obtained according to the result of performing the data binning method at the second time intervals with respect to the obtained data. That is, the first data may be divided into data which corresponds to the plurality of states, respectively, based on the second time intervals.

In an example, the eleventh sinogram generating unit 232 may extract second data corresponding to the location information regarding the plurality of states of the ROI in the first direction from the first data. For example, the eleventh sinogram generating unit 232 may extract the second data from the first data corresponding to the first state, the second state, and the third state, respectively. The first data and the second data may exist in the form of data obtained from the subject or in the form of sinograms.

In this example, the image data may provide the anatomic information of the subject with respect to one state, such that the location information regarding the first state, the second state, and the third state of the ROI in the first direction are the same as each other. Alternatively, and in another example, the first data corresponding to the first state, the first data corresponding to the second state, and the first data corresponding to the third state may be different from each other as a result of the movement of the subject and the ROI. Accordingly, in this example, the second data corresponding to the location information regarding the first state of the ROI in the first direction, the second data corresponding to the location information regarding the second state of the ROI in the first direction, and the second data corresponding to the location information regarding the third state of the ROI in the first direction may also be different from each other.

In an example, the eleventh sinogram generating unit 232 may combine the second data for the plurality of states, thereby generating the eleventh sinograms corresponding to each of the plurality of states of the ROI. For example, to combine the second data for the plurality of states, the eleventh sinogram generating unit 232 may sum or compress the second data in the z-axis direction for each of the plurality of states. For example, this process may be rebinning in the z-axis direction. Hence, the eleventh sinogram generating unit 232 may generate the eleventh sinograms with respect to the first direction of the plurality of states of the ROI.

In this example, if the location information with respect to the first direction of the ROI is location information regarding the slices #50 through #75 in the z-axis direction, the eleventh sinogram generating unit 232 may combine the second data corresponding to the plurality of states, respectively, in the z-axis direction. For example, the second data may exist in a form in which 2D sinograms are stacked in the z-axis direction. In this example, the eleventh sinogram generating unit 232 may combine 2D sinograms corresponding to location information regarding the slices #50-#75 in the z-axis direction, thereby generating the eleventh sinogram corresponding to the first state of the ROI. Similarly, the eleventh sinogram generating unit 232 may likewise generate the eleventh sinogram of the second and third states of the ROI. That is, the eleventh sinogram generating unit 232 combines 2D sinograms corresponding to the location information regarding the slices #50-#75 in the z-axis direction, thereby generating the eleventh sinograms corresponding to the plurality of states of the ROI, respectively.

Accordingly, in this example, the eleventh sinogram generating unit 232 may perform compression in the z-axis direction based on the location information of the ROI, such that the eleventh sinogram generating unit 232 may generate the eleventh sinograms using the 2D sinograms of the ROI.

In this example, the sinogram generator 230 may include a twelfth sinogram generating unit 234. The twelfth sinogram generating unit 234 may generate the twelfth sinogram corresponding to the second direction and the third direction of the ROI. The twelfth sinogram may be generated by using projection data obtained by projecting the ROI onto a plane defined by the second direction and the third direction of the image data. The plane defined by the second direction and the third direction may be an xy plane defined by an x axis and a y axis.

For example, the twelfth sinogram generating unit 234 may generate the twelfth sinogram by setting the ROI in the image data to 1 and setting the other regions in the image data to 0. The twelfth sinogram may obtain projection data through data processing. The obtained projection data may be the results of projecting the ROI onto the xy plane in the plurality of projection directions. By using the projection data, the twelfth sinogram generating unit 234 may generate the twelfth sinogram with respect to the second direction and the third direction of the ROI.

In this example, the sinogram generator 230 may also include a first sinogram generating unit 236. The first sinogram generating unit 236 may extract the region corresponding to the twelfth sinogram from each of the eleventh sinograms to generate the first sinograms. A first sinogram may be generated for each of the plurality of states. For example, the first sinogram generating unit 236 may perform masking with respect to each of the eleventh sinograms by using the twelfth sinogram, thereby generating the first sinograms for each of the plurality of states.

In the example where the plurality of states are a first, second, and third state, the first sinogram generating unit 236 may extract a region corresponding to the twelfth sinogram from the eleventh sinograms of the first, second, and third states, thereby generating a first sinogram for each of the three states.

Therefore, the sinogram generating unit 230 may generate first sinograms for each of the plurality of states of the ROI by using the eleventh sinogram generating unit 232, the twelfth sinogram generating unit 234, and the first sinogram generating unit 236.

Referring back to FIG. 2, the motion information estimation apparatus 200 may include an extracting unit 240. In this example, the extracting unit 240 may extract information about the anatomical, physiological, or biological features of the subject during each of the plurality of states. This information may be extracted using the first sinograms of the plurality of states that were generated by the sinogram generating unit 230. In particular, this information may be related to the anatomical features of the ROI during the plurality of states. The features of the ROI may provide further information about the general condition or biological state of the subject. Accordingly, the first sinograms may provide information about the ROI of the subject, such that information about the subject may be obtained from feature values of the ROI.

The feature values may indicate information about the subject that changes according to the plurality of states corresponding to the subject's motion. For example, if the motion information estimation apparatus 200 is included in a PET device, the feature values may include the amount of data emitted by a tracer injected into the subject. This information may be referred to as the activity of gamma rays emitted from a particular region, or simply as the activity. In this example, the feature values are not limited to the amount of data emitted by a tracer injected into the subject or the activity, and may include gradient values of the first sinograms, pixel values of pixels of the first sinograms, or sinogram form information of the first sinograms. The gradient values may indicate difference values between the pixel values of the pixels forming each sinogram and pixel values of pixels located adjacent to the pixels of the sinograms.

In this example, the motion information estimation apparatus 200 may also include an information estimation unit 250. The motion information estimating unit 250 may estimate motion information of the subject by referring to the extracted feature values with respect to the plurality of states. For example, the motion information estimating unit 250 may estimate motion information of the subject by referring to a pattern of a sum of the feature values of the subject with respect to the plurality of states. Hereinbelow, estimation of motion information of the subject will be described with reference to FIG. 4.

FIG. 4 is a diagram illustrating an example of a pattern of a sum of feature values of the subject with respect to the plurality of states. Referring to FIG. 4, a graph 41 indicates a pattern of a sum of the feature values of the subject with respect to the plurality of states. For example, if a feature value is an activity, the graph 41 may indicate activity sums for each of the plurality of states. Each of the plurality of states may fall within a different time instant at which data emitted from the subject is detected by a detector (not shown). Therefore, in this example, the x axis of the graph 41 is indicated by time. Alternatively, and in another example, the x axis may also show phases indicating the plurality of states. In this example, the y axis may be an activity sum which is converted into a value ranging from 0-1 to indicate a relative change of the activity sum of each of the plurality of states. The y axis may also show other feature values or ranges which are configured for display on a graph.

For example, the motion information of the subject may be information about the subject's breathing period. In this example, the motion information estimating unit 250 may estimate a breathing period by referring to the phase cycles of the graph 41. The motion information estimating unit 250 may also estimate the motion information of the subject by obtaining time information with respect to any one of the plurality of states corresponding to the subject's motion. For example, reference may be made to specific time information 421, 422, and 423 of specific points 411, 412, and 413 on the graph 41, at which sums of feature values of the subject are equal to each other. Based on this information, the breathing period or other motion information of the subject may be estimated.

In an example, the motion information estimation apparatus 200 may obtain time information with respect to each of the plurality of states of the subject corresponding to the subject's motion. For example, the time information with respect to each of the plurality of states corresponding to the subject's motion may be gating information. In this example, the motion information estimation operation performed by the motion information estimation apparatus 200 may be a gating operation.

According to this example, the motion information estimation apparatus 200 may estimate the motion information of the subject without a separate external device which contacts or does not contact the subject. That is, the motion information estimation apparatus 200 may estimate the motion information of the subject based on the image data of the subject and the data obtained from the subject, thereby improving the accuracy of the estimated motion information.

Referring back to FIG. 2, the main system 120 may also include a correcting unit 122. The correcting unit 122 may perform a correcting operation based on the motion information estimated by the motion information estimating unit 250. The motion correcting operation may be performed by using the time information of each of the plurality of states corresponding to the subject's motion. That is, the correcting unit 122 may calculate data or image error of one state with respect to another state of the subject. Based on the calculated error, the correcting unit 122 may correct the data or image error in the one state. In a similar operation, the correcting unit 122 may calculate error for a plurality of different states as compared to a plurality of other states.

For example, the correcting unit 122 may perform a correcting operation with respect to data obtained from the subject, a sinogram generated from data obtained from the subject, or an image generated by the image generating unit 124. The correcting unit 122 may reflect the corrected motion information into a system matrix of the image generation apparatus 100.

In this example, the main system 120 may also include an image generating unit 124. The image generating unit 124 may generate an image of the subject by referring to the motion information estimated by the motion information estimating unit 122. The image generated by the image generating unit 124 may be a gated image.

For example, the image generating unit 124 may generate the sinogram by using the data obtained from the subject. The generated sinogram may be reconstructed to generate the image of the subject. As another example, the image generating unit 124 may generate the image of the subject by using corrected results from the correcting unit 122.

For example, the image generating unit 124 may generate a high-resolution image from which motion blur corresponding to the subject's motion is removed.

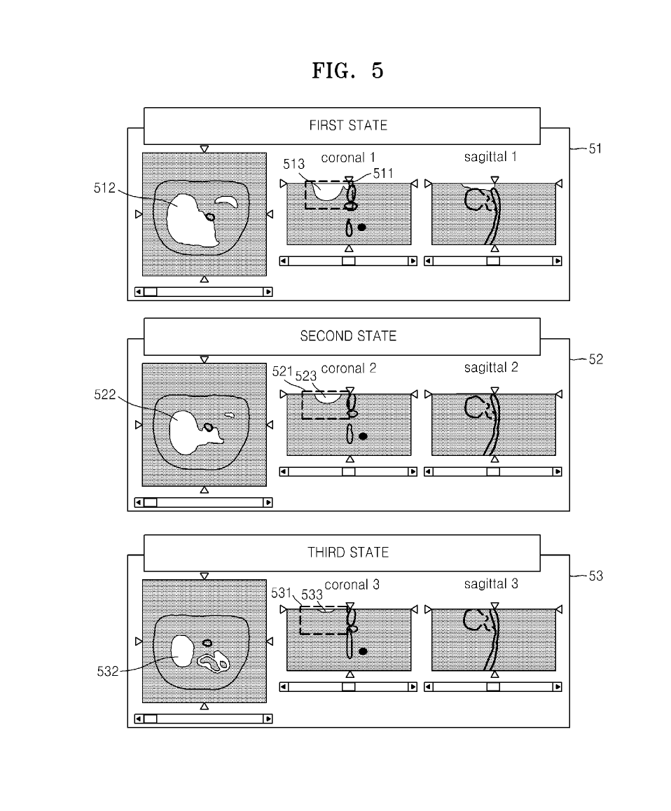

FIG. 5 is a diagram illustrating an example of a plurality of states of ROIs. Referring to FIG. 5, a plurality of different states 51, 52, and 53 corresponding to the subject's motion are shown. In this example, the ROIs 511, 521, and 531 are also show. The ROIs 511, 521, and 531 may generate motion resulting from the subject's motion.

For example, the ROIs 511, 521, and 531 may correspond to a part of the liver. In this example, the first ROI 511 may include the liver 512 and part of the liver 513 in a first state 51. The second ROI 512 may include the liver 522 and a part of the liver 523 in a second state 52. Finally, the third ROI 513 may include the liver 532 and a part of the liver 533 in a third state 53. Motion in the liver may be generated as a result of the subject's breathing motion. Accordingly, the liver's motion is also displayed in each of the first ROI 511, the second ROI 521, and the third ROI 531 of the first state 51, the second state 52, and the third state 53, respectively. In this example, due to the liver's motion, the first ROI 511 shows the largest liver part 513, and the third ROI 531 shows the smallest liver part 533.

Therefore, the motion information estimating unit 250 illustrated in FIG. 2 may estimate motion information of the subject. The motion information may be estimated by referring to a pattern of a sum of feature values of the ROIs with respect to the plurality of states 51, 52, and 53. For example, the feature values of the ROIs may be activity values. In this example, due to different sizes of the liver shown in the first ROI 511, the second ROI 521, and the third ROI 531, motion information of the subject may be estimated by referring to a pattern of a sum of the feature values with respect to the plurality of states 51, 52, and 53, respectively.

For example, the ROI may be a part of the liver in which much motion is generated. Other examples of the ROI may also include a tumor cell, a tumor tissue, or other organs in which much motion is generated corresponding to the subject's motion. Alternatively, the ROI may be a region where less motion is generated.

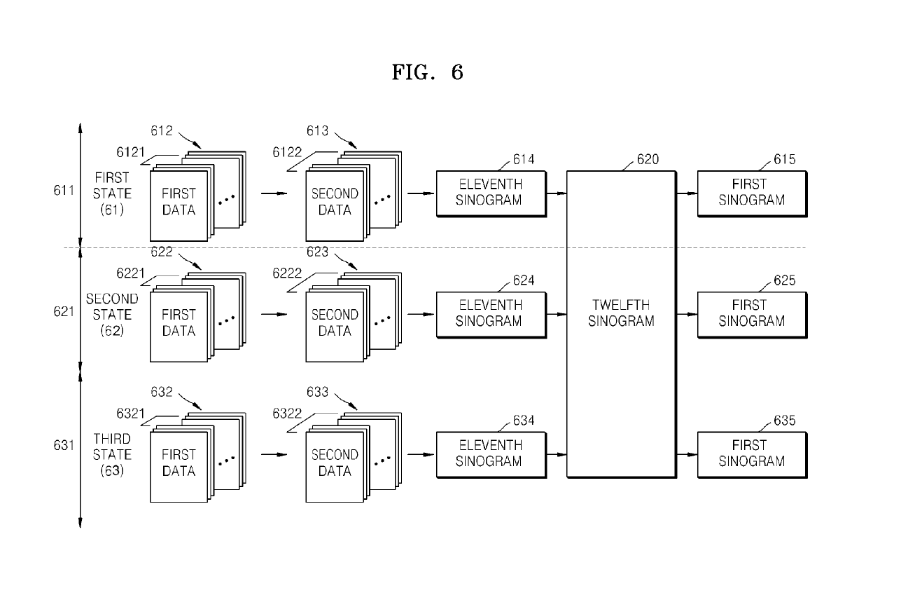

FIG. 6 is a diagram illustrating an example of a process for generating first sinograms in the sinogram generator 230. In this example, the plurality of states may include a first state 61, a second state 62, and a third state 63. Referring to FIG. 6, the first state 61, the second state 62, and the third state 63 may correspond to different states resulting from the subject's motion. The first state 61, the second state 62, and the third state 63 may have time intervals 611, 621, and 631 which are the same as each other, respectively. The time intervals 611, 621, and 631 may be the same as the second time intervals used for performing the data binning operation in the eleventh sinogram generating unit 232.

Referring to FIGS. 3 and 6, the eleventh sinogram generating unit 232 may obtain first data 612, 622, and 623 in which data obtained from the subject during the first time are arranged by equal time intervals 611, 621, and 631. Second data 613, 623, and 633 corresponding to location information in the first direction 6121, 6122, 6221, 6222, 6321, and 6322 may be extracted from the first data 612, 622, and 623. In an example, the location information 6121, 6122, 6221, 6222, 6321, and 6322 regarding the plurality of states 61, 62, and 63 of the ROI in the first direction may be the same as one another.

The eleventh sinogram generating unit 232 may combine the second data 613, 623, and 633 with respect to the plurality of states 61, 62, and 63, respectively, to generate eleventh sinograms 614, 624, and 634 for each of the plurality of states 61, 62, and 63 of the ROI in the first direction.

The twelfth sinogram generating unit 234 may generate a twelfth sinogram 620 corresponding to a second direction and a third direction of the ROI from the image data. Using the twelfth sinogram and the eleventh sinograms, the first sinogram generating unit 236 may generate first sinograms 615, 625, and 635 corresponding to each of the plurality of states 61, 62, and 63 of the ROI.

The extracting unit 240 may extract feature values of the ROI of the subject for the plurality of states 61, 62, and 63 from the first sinograms 615, 625, and 635, respectively. The motion information estimating unit 250 may estimate the motion information of the subject by referring to the feature values of the ROI of the subject with respect to the plurality of states 61, 62, and 63. For example, the motion information estimating unit 250 may estimate the motion information of the subject by referring to the pattern of the sum of the feature values with respect to the plurality of states 61, 62, and 63, respectively.

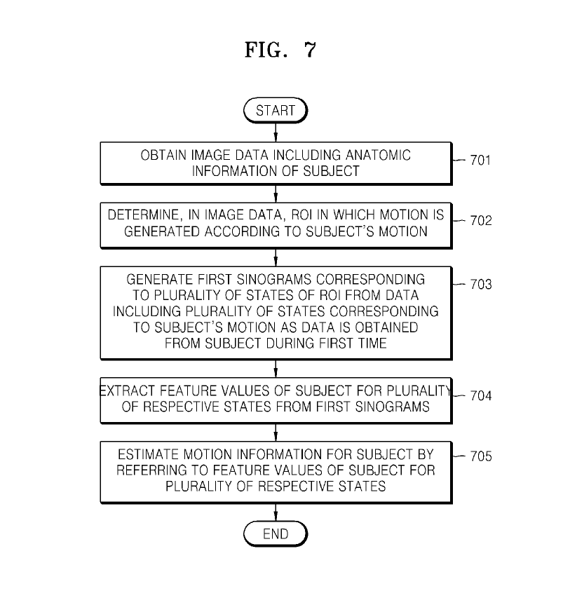

FIG. 7 is a flowchart illustrating an example of a motion information estimation method. Referring to FIG. 7, the motion information estimation method may include operations which are time-serially processed by the image generation apparatus 100 and the motion information estimation apparatus 200. Therefore, the foregoing description of the image generation apparatus 100 and the motion information estimation apparatus 200 may also be applied to the motion information estimation method of FIG. 7.

In operation 701, the image data obtaining unit 210 may obtain image data including anatomic information of the subject.

In operation 702, the ROI determining unit 220 may determine, in the image data, an ROI in which motion is generated corresponding to subject's motion.

In operation 703, the sinogram generating unit 230 may generate first sinograms corresponding to a plurality of states of the ROI from data including a plurality of states corresponding to the subject's motion as the data is obtained from the subject during a first time.

In operation 704, the extracting unit 240 may extract feature values of the subject with respect to the plurality of states, respectively, from the first sinograms.

In operation 705, the motion information estimating unit 250 may estimate motion information of the subject by referring to the feature values of the subject with respect to the plurality of states. The feature values of the subject may be feature values of the ROI of the subject.

In this example, the motion information of the subject may be accurately estimated, and a breathing period or phase of the subject may be obtained using the estimated motion information. Further, a gated image or a motion-blur-removed image of the subject may be generated using the estimated motion information.

As is apparent from the foregoing description the motion information of the subject may be accurately estimated.

The foregoing method can be embodied as a program which can be executed on a computer, and may be implemented using a computer-readable recording medium on a general-purpose digital computer which operates the program. A data structure used in the foregoing method may be recorded on a computer-readable recording medium through various means. Examples of the computer-readable recording medium may include recording media, such as magnetic storage media (e.g., ROM, RAM, USB, floppy disks, hard disks, etc.), optical recording media (e.g., CD-ROMs, or DVDs), a PC interface (e.g., PCI, PCI-express, WiFi, etc.).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image generation apparatus comprising:
an image data obtaining unit configured to obtain image data comprising anatomic information of a subject;
a region-of-interest (ROI) determining unit configured to determine a ROI in the image data corresponding to a region in which motion is generated in response to the subject's movement;
a sinogram generating unit configured to generate first sinograms corresponding to a plurality of states of the ROI from data obtained during a predetermined first time;
an extracting unit configured to extract feature values of the plurality of states from the first sinograms; and
a motion information estimating unit for estimating motion information of the subject based on the feature values.

2. The image generation apparatus of claim 1, wherein the motion generated in the ROI is a motion generated by the subject's diaphragm during a breathing motion of the subject, and the ROI comprises at least a part of a cell, a tissue, or an organ which is located adjacent to the diaphragm.

3. The image generation apparatus of claim 2, wherein the ROI comprises a part of a cell, a tissue, or an organ which has the largest amount of data emitted by a tracer among cells, tissues, or organs which are located adjacent to the diaphragm.

4. The image generation apparatus of claim 1, wherein the ROI determining unit automatically determines the ROI or manually determines the ROI based on input information input by a user of the image generation apparatus, and
the ROI comprises at least one of a part of a tumor cell, a tumor tissue, or a liver.

5. The image generation apparatus of claim 1, wherein the sinogram generating unit comprises:
an eleventh sinogram generating unit configured to generate eleventh sinograms corresponding to a first direction of the ROI for the plurality of states based on location information with respect to the first direction of the ROI obtained from the image data;
a twelfth sinogram generating unit configured to generate a twelfth sinogram corresponding to a second direction and a third direction of the ROI by using projection data obtained by projecting the ROI onto a plane, which is defined by the second direction and the third direction; and
a first sinogram generating unit configured to extract a region corresponding to the twelfth sinogram from the eleventh sinograms and to generate the first sinograms for the plurality of states of the ROI.

6. The image generation apparatus of claim 5, wherein the eleventh sinogram generating unit obtains first data from the subject during the first time and arranges the first data at intervals of a second time, extracts second data corresponding to the location information within the first direction of the plurality of states of the ROI from the first data, and combines the second data for the plurality of states, respectively, thereby generating the eleventh sinograms corresponding to the plurality of states of the ROI.

7. The image generation apparatus of claim 6, wherein the eleventh sinogram generating unit obtains the first data by using a data binning method with respect to time.

8. The image generation apparatus of claim 1, wherein the feature values of the subject comprise the amount of data emitted by a tracer injected into the subject.

9. The image generation apparatus of claim 1, wherein the motion information estimating unit estimates the motion information of the subject based on a pattern of a sum of the feature values with respect to the plurality of states.

10. The image generation apparatus of claim 1, further comprising an image generating unit configured to generate an image of the subject based on the estimated motion information.

11. An image generation apparatus comprising:
a detector for detecting data corresponding to a plurality of states occurring in response to a subject's movement during a predetermined first time; and
a main system for determining a region-of-interest (ROI) corresponding to a region in which motion is generated in response to the subject's movement, generating first sinograms corresponding to the plurality of states of the ROI from the detected data, estimating motion information of the subject based on feature values of the plurality of states, and generating a gated image based on the estimated motion information.

12. A motion information estimation method comprising:
obtaining image data comprising anatomic information of a subject;
determining a region-of-interest (ROI) in the image data corresponding to a region in which motion is generated in response to the subject's movement;
generating first sinograms corresponding to a plurality of states of the ROI from data obtained during a predetermined first time;
extracting feature values of the plurality of states from the first sinograms; and
estimating motion information of the subject based on the feature values.

13. The motion information estimation method of claim 12, wherein the motion generated in the ROI occurs in response to motion generated by the subject's diaphragm during a breathing motion of the subject, and the ROI comprises at least a part of a cell, a tissue, or an organ which is located adjacent to the diaphragm.

14. The motion information estimation method of claim 12, wherein the ROI comprises a part of a cell, a tissue, or an organ which has the largest amount of data emitted by a tracer among cells, tissues, or organs which are located adjacent to the diaphragm, and the ROI is automatically determined or manually determined with reference to input information input by a user.

15. The motion information estimation method of claim 12, wherein the generating of the first sinograms comprises:
generating eleventh sinograms corresponding to a first direction of the ROI of the plurality of states based on location information with respect to the first direction of the ROI obtained from the image data;
generating a twelfth sinogram corresponding to a second direction and a third direction of the ROI by using projection data obtained by projecting the ROI onto a plane, which is defined by the second direction and the third direction; and
extracting a region corresponding to the twelfth sinogram from the eleventh sinograms to generate the first sinograms for the plurality of states of the ROI.

16. The motion information estimation method of claim 15, wherein the generating of the eleventh sinograms comprises:
obtaining first data from the subject during the first time and arranging the first data at intervals of a second time;
extracting second data corresponding to the location information within the first direction of the plurality of states of the ROI from the first data; and
combining the second data for the plurality of states, respectively, to generate the eleventh sinograms corresponding to the plurality of states of the ROI.

17. The motion information estimation method of claim 16, wherein the obtaining of the first data is performed using a data binning method with respect to time.

18. The motion information estimation method of claim 12, wherein the feature values of the subject comprise the amount of data emitted by a tracer injected into the subject.

19. The motion information estimation method of claim 12, further comprising estimating the motion information of the subject based on a pattern of a sum of the feature values with respect to the plurality of states.

20. A computer-readable recording medium having recorded thereon a computer program for executing the motion information estimation method of claim 12 on a computer.
